(19) United States
(12) Patent Application Publication
(10) Pub. No.: US 2019/0379749 A1
(43) Pub. Date: Dec. 12, 2019

(54) SYSTEM AND METHOD FOR LOCATION-BASED IMAGE CAPTURE BETWEEN MOBILE DEVICES

(71) Applicant: Erik D. Ovesny, Lyndhurst, OH (US)

(72) Inventor: Erik D. Ovesny, Lyndhurst, OH (US)

(21) Appl. No.: 16/463,167

(22) PCT Filed: Nov. 22, 2017
(86) PCT No.: PCT/US17/63046

§ 371 Date: May 22, 2019

Related U.S. Application Data
(60) Provisional application No. 62/425,165, filed on Nov. 22, 2016.

(51) Int. Cl. H04L 29/08; G06F 16/58; G06F 16/78

(52) U.S. Cl. CPC H04L 67/18; H04L 67/04; G06F 16/7867; G06F 16/58; H04L 67/06

(57) ABSTRACT

A system and method for leveraging the disparate positions of mobile devices with image capture capabilities to procure images of a requested item, is provided hereinafter. A first mobile device, in communication with a central server, submits a request for an image of a particular subject. Upon receipt of the image request, the central server determines, using the keywords contained therein, identifies a location associated with the requested image. The central system identifies images corresponding to the keywords and determined location in its or a third party repository of images. The central system also identifies one or more mobile devices located in relative proximity to the identified location and sends an image request for the image (using the aforementioned keywords). As those mobile devices proximate to the location submit new images, the central system facilitates the communication of all images, albeit in a non-reproducible format, to the requesting mobile device. Once an image is selected by the first mobile device, a high-resolution image with or without usage constraints, depending on the user and/or rights associated with the image, is communicated to the first mobile device. Various user accounts, where appropriate, are then updated to reflect the transfer or purchase.

### CROSS-REFERENCE TO RELATED APPLICATIONS

This application claims priority to U.S. Provisional Patent Application Ser. No. 62/425,165, filed on Nov. 22, 2016. The entirety of that application is hereby fully incorporated by reference.

### BACKGROUND

The subject disclosure is directed to the photographic arts, the communications arts, the digital image processing arts, the video processing arts, the radio communications arts, the mobile computing arts, the positioning system arts, and the like.

Currently, imaging searching is a difficult task, involving a plurality of different image sources. Free to use applications, such as GOOGLE Image Search return images that may or may not be in the public domain, free to use, etc. Other, proprietary image services may have a large volume of “stock” images from which to choose, but these services require a substantial outlay in funds and may require commitments by the requesting party as to usage rights. In addition to the foregoing, another limitation inherent in the publically available searching are specifics in the image being searched. For example, when searching for an image containing A, B, C, and D, the image search will return results including A and B, but not having C and D, or various permutations thereof. Thus, additional time must be spent analyzing search results for the image or images that are actually responsive to the query.

Furthermore, it may be difficult to obtain a current image, as publically available services, such as the aforementioned GOOGLE, may not have such an image logged or available. For example, should a user desire to obtain an image of an ongoing construction event, absent a news story (GOOGLE) or a professional photographer (proprietary service) sent to photograph that day, the user will be unable to acquire a suitable photograph. Similarly, the aforementioned GOOGLE may have an image available, but this image is too distant from the item being captured. Alternatively, the publically available services may not be able to provide time-sensitive images, e.g. a photograph of an ongoing sporting event. In addition, when time is an issue, i.e., an approaching deadline, obtaining the desired image quickly is necessary, and current stock photograph services, e.g., SHUTTERSTOCK, GETTY IMAGES, etc., incur a substantial cost to the user.

Accordingly, what is needed is a system and method that leverages the ubiquitous personal smart phones carried by users around to the world with their integrated positioning systems to obtain a desired photograph and/or video.

### BRIEF DESCRIPTION

In one aspect of the exemplary embodiment, a method for location-based image capture between mobile devices is presented. The method includes receiving, from a first mobile device via a computer network, an image request comprising at least one keyword, and identifying a location corresponding to the image request in accordance with the at least one keyword. The method further includes identifying a second mobile device in proximity to the identified location having an image capture device, and communicating the image request to this identified second mobile device via the computer network. In addition, the method includes receiving at least one image responsive to the image request from the identified second mobile device, and generating a notification responsive to the at least one image received from the identified second mobile device. Furthermore, the method includes communicating the generated notification of the at least one image to the first mobile device via the computer network, wherein at least one of the receiving, identifying, and communicating is performed by a computer processor of a central computer system in communication with memory.

### BRIEF DESCRIPTION OF THE DRAWINGS

FIG. 1 is a functional block diagram of a system for location-based image capture between mobile devices in accordance with one aspect of the exemplary embodiment.

FIG. 2 is a functional block diagram of a user device used in the location-based image capture between mobile devices system in accordance with one aspect of the exemplary embodiment.

FIG. 3 is a flowchart that illustrates one aspect of the method for location-based image capture between mobile devices according to an exemplary embodiment.

FIG. 4 is a representative illustration of a graphical user interface on the user device for interacting with the location-based image capture between mobile devices system according to an exemplary embodiment of the subject application.

FIGS. 5A and 5B are representative illustrations of a graphical user interface on the user device for interacting with the location-based image capture between mobile devices system according to exemplary embodiments of the subject application.

FIG. 6 is a representative illustration of a graphical user interface on the user device for interacting with the location-based image capture between mobile devices system according to an exemplary embodiment of the subject application.

FIG. 7 is another representative illustration of a graphical user interface on the user device for interacting with the location-based image capture between mobile devices system according to an exemplary embodiment of the subject application.

FIG. 8 is a representative illustration of a graphical user interface on the user device for interacting with the location-based image capture between mobile devices system according to an exemplary embodiment of the subject application.

FIGS. 9A and 9B are additional representative illustrations of graphical user interfaces on the user device for interacting with the location-based image capture between mobile devices system according to exemplary embodiments of the subject application.

### DETAILED DESCRIPTION

One or more embodiments will now be described with reference to the attached drawings, wherein like reference numerals are used to refer to like elements throughout.

In one aspect, a system and method for leveraging the disparate positions of mobile devices with image capture capabilities to procure images of a requested item, is provided hereinafter. It will be understood that while the term “images” is utilized hereinafter, image capture includes the capture of video, as mobile devices include the ability to capture streams of images, i.e., video, as well as still images. Accordingly, videos and images are understood hereinafter to be interchangeable in accordance with the systems and methods disclosed herein. A first mobile device, in communication with a central server, submits a request for an image of a particular subject. Upon receipt of the image request, the central server determines, using the keywords contained therein, identifies a location associated with the requested image. The central system identifies images corresponding to the keywords and determined location in its or a third party repository of images. The central system also identifies one or more mobile devices located in relative proximity to the identified location and sends an image request for the image (using the aforementioned keywords). As those mobile devices proximate to the location submit new images, the central system facilitates the communication of all images, albeit in a non-reproducible format, to the requesting mobile device. Once an image is selected by the first mobile device, a high-resolution image with or without usage constraints, depending on the user and/or rights associated with the image, is communicated to the first mobile device. Various user accounts, where appropriate, are then updated to reflect the transfer or purchase.

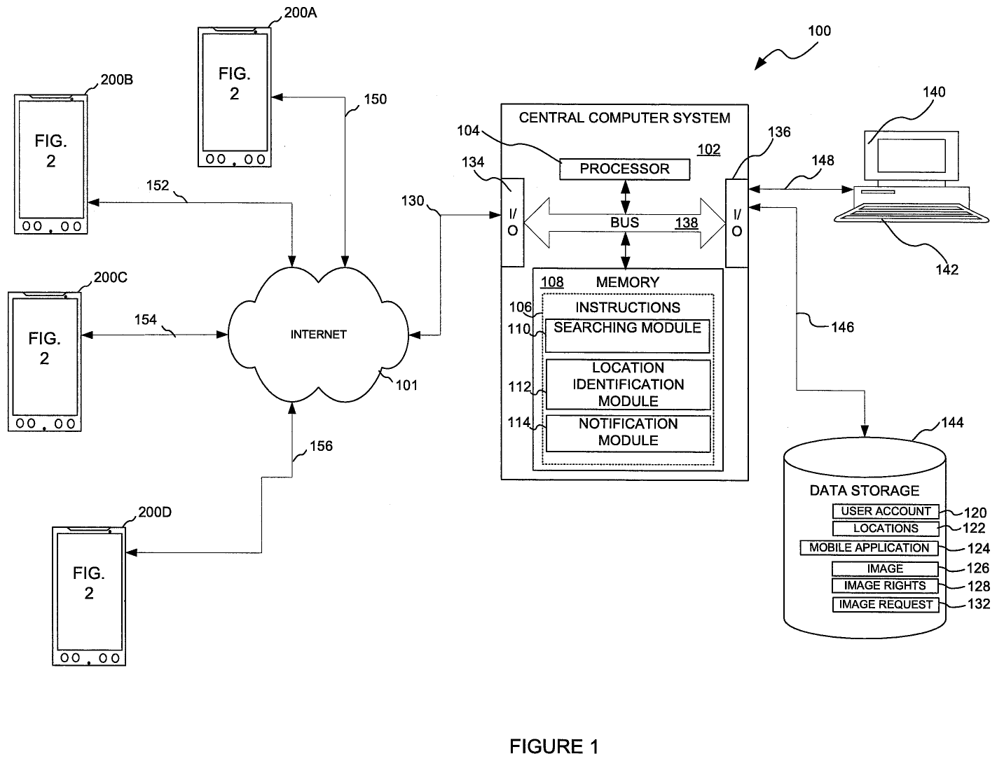

Referring now to FIG. 1, there is shown a system 100 configured for providing location-based image capture between mobile devices. It will be appreciated that the various components depicted in FIG. 1 are for purposes of illustrating aspects of the exemplary embodiment, and that other similar components, implemented via hardware, software, or a combination thereof, are capable of being substituted therein.

As shown in FIG. 1, the system 100 includes a central system represented generally as the central computer system 102, which is capable of implementing the exemplary method described below. The exemplary computer system 102 includes a processor 104, which performs the exemplary method by execution of processing instructions 106 that are stored in memory 108 connected to the processor 104, as well as controlling the overall operation of the computer system 102.

The instructions 106 include a searching module 110 configured to receive, from a notification module 114 (discussed below), keywords and associated information to conduct a search for images 124 corresponding to the keywords in an image request 132.

The instructions 106 also include a location identification module 112 that, when implemented by the processor 104, facilitates the identification of locations 122 associated with keywords in a received image request 132, locations of mobile devices 200A-D, and the like. The searching module 110 and the location identification module 112 thereafter work in concert, via the processor 104, to search for images 124 that correspond to the location 122 identified as relating to the keywords in the received image request 132.

In addition, the instructions 106 include a notification module 114, which when executed by the processor 104, facilitates the communications between the central computer system 102 and the mobile devices 200A-200D. In accordance with one embodiment, the notification module 114 receives image requests 132 from a mobile device 200A-D, generates responses to the mobile device 200A-D, generates notifications for images 126, receives images 126 from mobile device 200A-D, and myriad other communications, as will be appreciated, in accordance with the systems and methods set forth herein.

The various components of the computer system 102 associated with the central system 101 may all be connected by a data/control bus 138. The processor 104 of the computer system 102 is in communication with an associated date storage 144 via a link 146. A suitable communications link 146 may include, for example, the public switched telephone network, a proprietary communications network, infrared, optical, or other suitable wired or wireless data communications. The data storage 144 is capable of implementation on components of the computer system 102, e.g., stored in local memory 108, i.e., on hard drives, virtual drives, or the like, or on remote memory accessible to the computer system 102.

The associated data storage 144 corresponds to any organized collections of data (e.g., account information, images, locations, usage rights, copyright instructions, image requests, mobile device information) used for one or more purposes. Implementation of the associated data storage 144 is capable of occurring on any mass storage device(s), for example, magnetic storage drives, a hard disk drive, optical storage devices, flash memory devices, or a suitable combination thereof. The associated data storage 144 may be implemented as a component of the computer system 102, e.g., resident in memory 108, or the like.

In one embodiment, the associated data storage 144 may include data corresponding to user accounts 120, locations 122, images 126, image rights 128, image requests 132, mobile applications 124 (for direct download by mobile devices 200A, 200B, 200C, 200D, or the like), and other corresponding data, e.g., website data hosted by the central computer system 102, and the like. The user account information 120 may include, for example, user name, billing information, mobile device 200A-D identification, address, passwords, and the like. Such user account information 120 may be collected by the central computer system 102 during user registration of a mobile device 200A, 200B, 200C, 200D, as discussed below. The image rights 128 may include, for example, instructions on the number of reproductions to be made, the cost associated with reproducing the corresponding image 126, ownership of the copyright of the image 126, watermarks or attribution information, any myriad additional information relating to the transfer, usage, sale, authorship, and the like relating to a corresponding image 126. In some embodiments, the user account 120 may include preselected image rights 128 to be applied to any images 126 the corresponding mobile device 200A-D submits. In other embodiments, the image rights 128 associated with a user account 120 may include instructions as to the types of rights that the user requires for any images 126 requested by the corresponding mobile device 200A-D. In still another embodiment, image rights 128 for an image 126 submitted by a particular user account 120 may be determined by the processor 104 of the central system 102 in accordance with the history of the user account 120, e.g., the rights selected in the past may be applied to a newly submitted image 126 absent user intervention, or the like.

The computer system 102 may include one or more input/output (I/O) interface devices 134 and 136 for communicating with external devices. The I/O interface 136 may communicate, via communications link 148, with one or more of a display device 140, for displaying information, such estimated destinations, and a user input device 142, such as a keyboard or touch or writable screen, for inputting text, and/or a cursor control device, such as mouse, trackball, or the like, for communicating user input information and command selections to the processor 104. The I/O interface 134 may communicate, via communications link 130, with external devices 200A, 200B, 200C, 200D via a computer network, e.g., the Internet 128.

It will be appreciated that the location-based image capture between mobile devices system 100 is capable of implementation using a distributed computing environment, such as a computer network, which is representative of any distributed communications system capable of enabling the exchange of data between two or more electronic devices. It will be further appreciated that such a computer network includes, for example and without limitation, a virtual local area network, a wide area network, a personal area network, a local area network, the Internet, an intranet, or the any suitable combination thereof. Accordingly, such a computer network comprises physical layers and transport layers, as illustrated by various conventional data transport mechanisms, such as, for example and without limitation, Token-Ring, Ethernet, or other wireless or wire-based data communication mechanisms. Furthermore, while depicted in FIG. 1 as a networked set of components, the system and method are capable of implementation on a stand-alone device adapted to perform the methods described herein.

The central computer system 102 may include a computer server, workstation, personal computer, cellular telephone, tablet computer, pager, combination thereof, or other computing device capable of executing instructions for performing the exemplary method.

According to one example embodiment, the central computer system 102 includes hardware, software, and/or any suitable combination thereof, configured to interact with an associated user, a networked device, networked storage, remote devices, or the like.

The memory 108 may represent any type of non-transitory computer readable medium such as random access memory (RAM), read only memory (ROM), magnetic disk or tape, optical disk, flash memory, or holographic memory. In one embodiment, the memory 108 comprises a combination of random access memory and read only memory. In some embodiments, the processor 104 and memory 108 may be combined in a single chip. The network interface(s) 134, 136 allow the computer to communicate with other devices via a computer network, and may comprise a modulator/demodulator (MODEM). Memory 108 may store data the processed in the method as well as the instructions for performing the exemplary method.

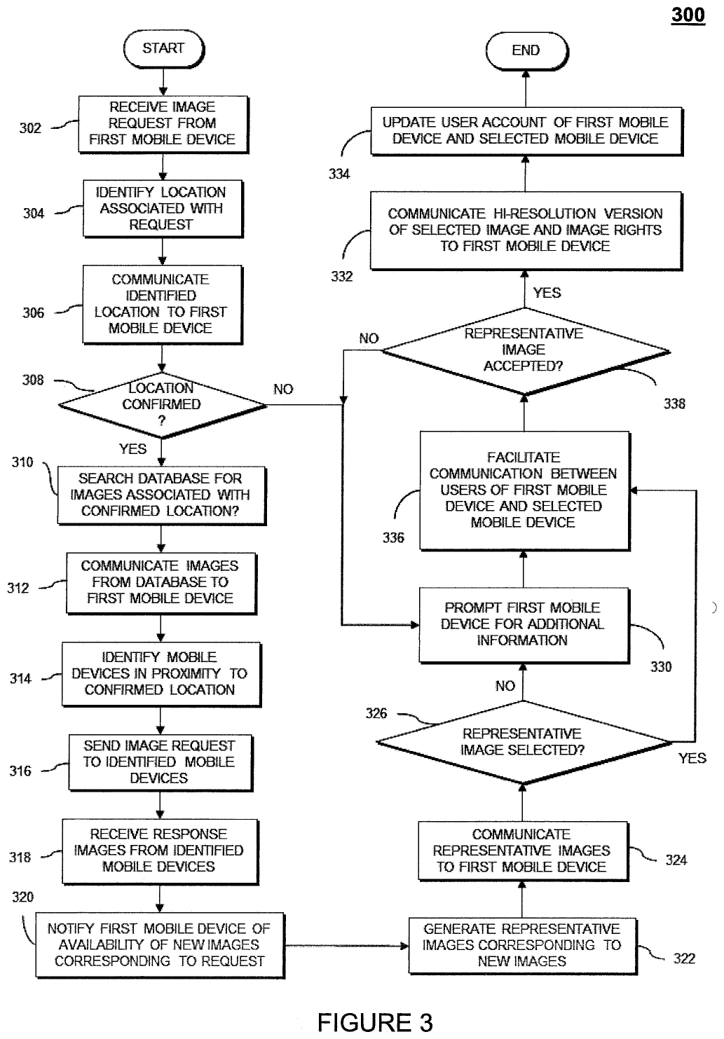

The digital processor 104 can be variously embodied, such as by a single core processor, a dual core processor (or more generally by a multiple core processor), a digital processor and cooperating math coprocessor, a digital controller, or the like. The digital processor 104, in addition to controlling the operation of the computer 102, executes instructions 106 stored in memory 108 for performing the method outlined in FIG. 3.

As shown in FIG. 1, one or more mobile devices 200A, 200B, 200C, and 200D may be in communication with the central computer system 102 via respective communication links 150, 152, 154, and 156, utilizing a computer network 128, e.g., the Internet. In one embodiment, each mobile device 200A, 200B, 200C, 200D may be implemented as a smartphone employing an operating system such as iOS, ANDROID, BLACKBERRY, WINDOWS, or the like. The mobile devices 200A-200D are representative of any personal computing devices, such as personal computers, netbook computers, laptop computers, workstation computers, personal data assistants, web-enabled cellular telephones, tablet computers, proprietary network devices, or other web-enabled electronic devices. The data communications links 150-156 between the central computer system 102 and the mobile devices 200A-200D may be accomplished via any suitable channel of data communications such as wireless communications, for example Bluetooth, WiMax, 802.11a, 802.11b, 802.11g, 802.11(x), a proprietary communications network, infrared, optical, the public switched telephone network, or any suitable wireless data transmission system, or wired communications. In one embodiment, the mobile devices 200A-200D may communicate with the central computer system 102 via a cellular data network.

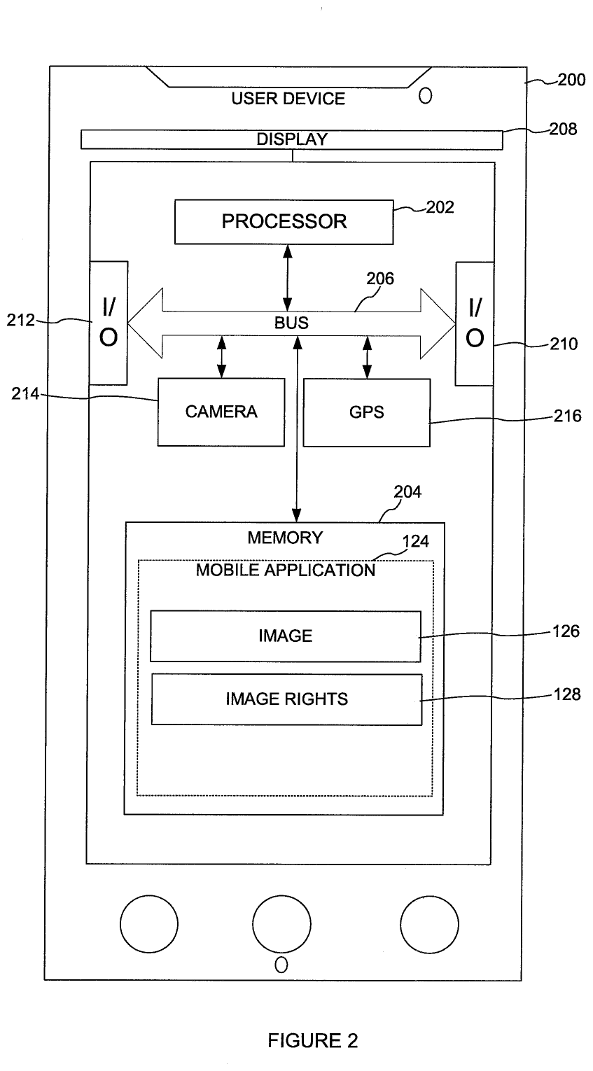

FIG. 2 provides an example illustration of a mobile device 200 representative of the mobile devices 200A-200D depicted in FIG. 1. The mobile device 200 may include a processor 202, which executes one or more instructions or applications 124 in the performance of an exemplary method discussed below. The mobile device 200 may further include a memory 204 storing the application 124 in data communication with the processor 202 via a system bus 206. The processor 202 of the mobile device 200 may be in data communication with the central computer system 102 via an I/O interface 212 or I/O interface 210. The mobile device 200 may further include a display 208 suitably configured to display data to an associated user, receive input from the associated user, and the like. In some embodiments, the display 208 of the mobile device 200 may be configured as a touch-screen display capable of receiving user instructions via user contact on the display, e.g., LCD, AMOLED, LED, RETINA, etc., types of touch-screen displays.

The memory 204 may represent any type of non-transitory computer readable medium such as random access memory (RAM), read only memory (ROM), magnetic disk or tape, optical disk, flash memory, or holographic memory. In one embodiment, the memory 204 comprises a combination of random access memory and read only memory. In some embodiments, the processor 202 and memory 204 may be combined in a single chip. The network interface(s) 210, 212 allow the mobile device 200 to communicate with other devices via a communications network, and may comprise a modulator/demodulator (MODEM). Memory 204 may store data the processed in the method as well as the instructions for performing the exemplary method. The digital processor 202 can be variously embodied, such as by a single core processor, a dual core processor (or more generally by a multiple core processor), a digital processor and cooperating math coprocessor, a digital controller, or the like.

The memory 204 of the mobile device 200 includes the application 124 communicated from the central computer system 102 during registration of the mobile device 200, and creation of the user account 120. The application 124 stored in memory 204 may be made available via a third party service, e.g., GOOGLE PLAY, ITUNES, or the like. The mobile device 200 may be configured to further store one or more images 126 captured by the image capture device 214, received from the central computer system 102 responsive to an image request 132, as well as any user-specified image rights 128 corresponding to images 126 captured by the mobile device 200 or associated with images 126 received in response to an image request 132, or the like. The mobile device 200 further includes a location determination component, illustrated in FIG. 2 as a GPS transceiver 216. It will be appreciated that the GPS transceiver 216 is capable of determining the position of the mobile device 200 utilizing satellite communication signals. In other embodiments, for example when GPS signals are blocked, the processor 202 of the mobile device 200 may utilize other communication signals, e.g., WI-FI, cellular, GLONASS, RF triangulation, etc., or an internal navigation (compass) component, to ascertain the position of the mobile device 200. The mobile device 200 may send, and the central computer system 102 may receive, such a position signal in order to determine whether the mobile device 200 is in proximity to an identified location.

As shown in FIG. 1, the user devices 200A-200D are capable of intermittent (opportunistic) or continuous bi-directional communication with the central computer system 102 utilizing the I/O interface 212. In one embodiment, the bi-direction communication is data communication utilizing a cellular data network, e.g., 3^{rd} generation mobile phone standards (3G), 4^{th} generation standards (4G, 4G LTE, WiMax), EV-DO, standalone data protocols, and the like. The user device 200A-200D may provide account information 120 to the central computer system 102 during registration therewith. The central computer system 102 may then register the user associated with the user device 200A-200D.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

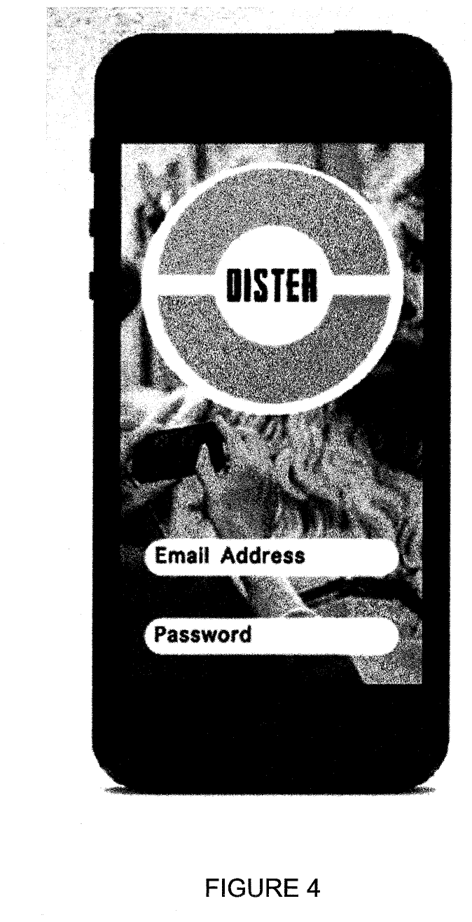

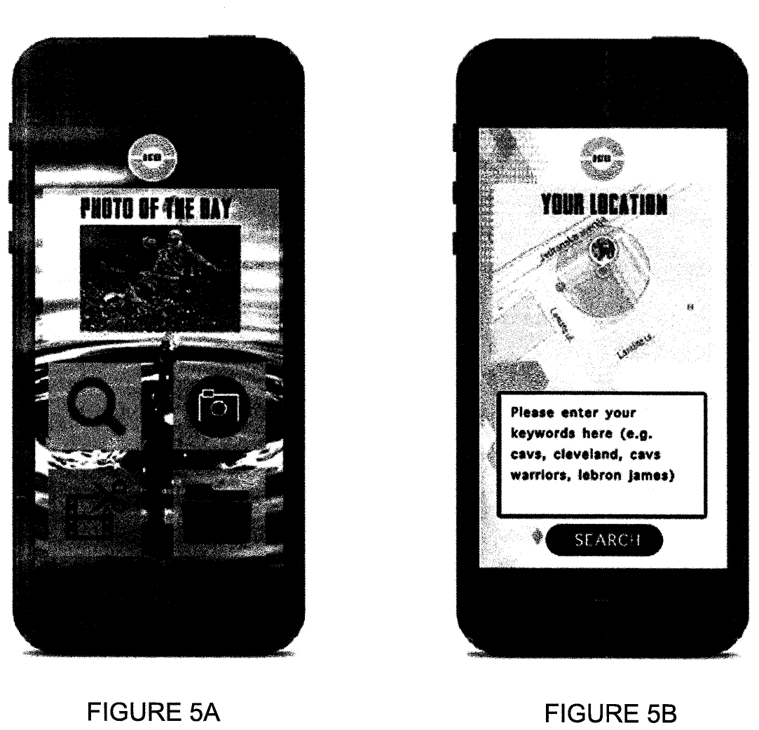

Operations of the system 100 will better be understood in conjunction with the flowchart 300 illustrating an exemplary method for location-based image capture between mobile devices in accordance with one embodiment of the subject application. Turning now to FIG. 3, there is shown a flowchart 300 illustrating one embodiment of the method for location-based image capture between mobile devices. At 302, a request is received from a first mobile device 200A, the request 132 including one or more keywords corresponding to a desired image. The request 132 may further include location data representative of the location of the first mobile device 200A, as well as user account information 120 associated with the first mobile device 200A. For example, a first user device 200A, after installing and registering the application 124, submits an image request 132 to the central computer system 102 via the Internet 128. Alternatively, the first user device 200A may submit an image request 132 utilizing a thin client interface, e.g., web browser, and communicating with the central computer system 102 via a website hosted thereby. The request 132 generally includes one or more keywords identifying the image 126 desired, as well as the location of the first mobile device 200A. An exemplary progression of user interactions with the first mobile device 200A are illustrated in FIGS. 4-9B. Thus, as shown, FIG. 4 presents a welcome/login screen to the user on the display 208 of the first mobile device 200A, FIG. 5A illustrates several initial user options (e.g. a search function, a camera function, and editing function, and a memory function), and FIG. 5B depicts various keywords for incorporation into an image request 132 in accordance with the methodology depicted in FIG. 3.

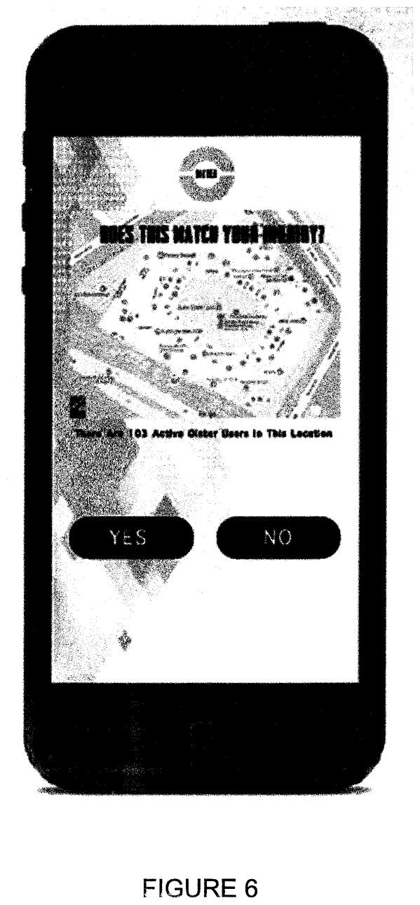

The central computer system 102 then identifies, at 304, a location 122 associated with the received image request 132. In accordance with one embodiment, the central computer system 102 accesses commercially available mapping services to identify a particular location associated with the keywords and other indicia included in the received image request 132. At 306, the central computer system 102 communicates the identified location 122 to the first mobile device 200A for confirmation thereof. FIG. 6 illustrates a graphical user interface depiction of the location confirmation screen displayed to the user on the first mobile device 200A in response to the image request shown in FIG. 5B. As shown, the example image request corresponded to keywords relating to LEBRON JAMES, CLEVELAND CAVALIERS, and the like. The central computer system 102 analyzed this input and correlated the keywords with a particular location, e.g., QUICKEN LOANS ARENA. A determination is then made, at 308, whether the location 122 identified by the central computer system 102 is confirmed by the first mobile device 200A. Upon a negative determination, operations proceed to 330, whereupon the first mobile device 200A is prompted for additional information as to the image request 132. For example, the request shown in FIG. 5B includes additional keywords, i.e., PISTONS, PLAYOFFS, etc., which may indicate the requesting user desires images relating to DETROIT. Thus, the location 122 depicted in FIG. 6 would be incorrect and additional information solicited from the user as discussed herein.

Upon a positive determination at 308, operations proceed to 310, whereupon the central computer system 102, via the searching module 110, searches the data storage 144 for any images 126 that match the keywords of the submitted image request 132. In some embodiments, the central computer system 102 may search a third-party storage (not shown) or utilize a third-party image search (e.g., GOOGLE image search) using the received keywords for suitable images 126. Images 126 that are retrieved from the data storage 144 (or third-party service) are then communicated to the first mobile device 200A at 312. In accordance with one embodiment, the images 126 are communicated in a reduced resolution or with a watermark or other indicia embedded therein, so as to preclude the first mobile device 200A from unauthorized copying and/or reproduction of such an image 126.

Contemporaneously, at 314, the location identification module 112 or other suitable component of the central computer system 102 identifies one or more mobile devices 200B, 200C, 200D that are in proximity to the confirmed location 122. Proximity may be determined via GPS or other location-based information submitted by the mobile devices 200B-200D running the application 124, via periodic location reporting by the devices 200B-200D to the central computer system 102, or other suitable reporting methodologies to enable the central computer system 102 to determine the location of the mobile devices 200B-200D when an image request 132 is received. It will be appreciated that the term “proximity” may be pre-set at the central computer system 102 such that those mobile devices 200B-200D within a predetermined radius of the confirmed location 122 are identified for notification. The predetermined radius may be adjusted based upon speed, initial location, mode of travel, travel time to the location 122 from the device's current location, user rating associated with the device 200B-200D, type of device 200B-200D, connection speed of network, or myriad other factors impacting fulfillment of an image request 132.

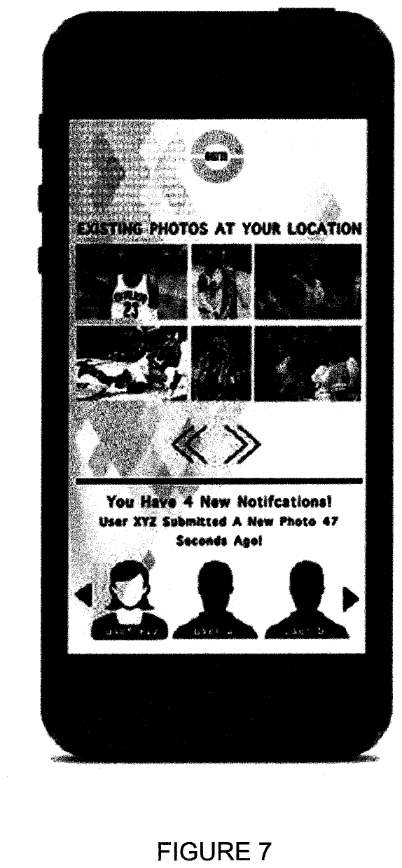

At 316, the image request 132 is communicated from the central computer system 102 to the identified mobile devices 200B-D. That is, at step 316, the central computer system 102 sends the image request 132 received from the first mobile device to the one or more mobile devices 200B-200D identified as being in proximate to the location 122 identified from the image request 132. On or more responses are then received from the mobile devices 200B-200D corresponding to the image request 132. In one embodiment, the responses include at least one image 126 that corresponds to the image of the image request 132. The first mobile device 200A is then notified by the central computer system 102 at 320, via the notification module 114, of the availability of one or more new images 126 captured by the one or more mobile devices 200B-200D reflecting the image request 132. An example of such a notification is depicted in FIG. 7, wherein the images 126 available via the data storage 144 are presented on the first mobile device 200A, and additional images are indicated as being available from different users submitted in response to the image request 132.

At 322, the central computer system 102 generates representative images of those new images submitted by the mobile devices 200B-200D responsive to the image request 132. It will be appreciated that such representative images may reflect lower quality/resolution images of newly captured images responsive to the image request 132, watermarked or other indicia formatted images, or the like (as discussed above). These representative images are then communicated to the first mobile device 200A at 324 by the central computer system 102, via the computer network 128 or other suitable communications means. In some embodiments, the central computer system 102, via the mobile application 124, communicates the representative images via text messaging, email, direct display via a thin client interface resident on the first mobile device 200A (e.g., a direct web browser interface, and the like).

At 326, a determination is made whether the user associated with the first mobile device 200A has selected a representative image 126 previously captured and stored in the data storage 144. That is, a determination is made by the central computer system 102 whether the user associated with the mobile device 200A has selected an image 126 that was previously collected from a mobile device 200A-200D and is available for transmission to the first mobile device 200A.

Upon a negative determination at 326, operations proceed to 330, whereupon the central computer system 102, via the notification module 114, prompts the first mobile device 200A for additional information, e.g., additional keywords, location information, timeframe, etc. Operations then return to step 304 and continue as discussed in greater detail above.

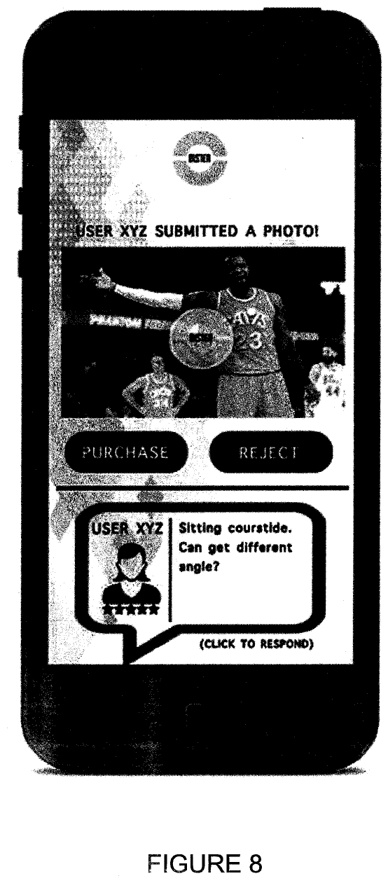

Upon a positive determination that an image 126 from the data storage 144 has been selected, operations proceed to 336, whereupon the central computer system 102 facilitates the establishment of a secure communications channel between the first mobile device 200A and the mobile device 200B, 200C, or 200D that is associated with the image selected by the first device 200A. It will be appreciated that such communications channel may be used to negotiate pricing, licensing rights, purchase rights, usage rights, and the like, between the corresponding users. FIG. 8 illustrates a graphical user interface of one embodiment of how a user associated with the first mobile device 200A may utilize the communications channel established at 336. As also shown in FIG. 8, the central computer system 102, via the notification module 114, prompts the user associated with the first mobile device 200A to accept (e.g. purchase) or reject the selected image 126. At 338, a determination is made whether the user associated with the first mobile device 200A has accepted (e.g. purchased) or rejected the selected representative image 126. Upon a negative determination at 338, operations proceed to 330, whereupon the central computer system 102, via the notification module 114, prompts the first mobile device 200A for additional information, e.g., additional keywords, location information, timeframe, etc. Operations then return to step 304 and continue as discussed in greater detail above.

Upon a positive determination that a selected image 126 has been accepted (e.g. purchased), operations proceed to 332.

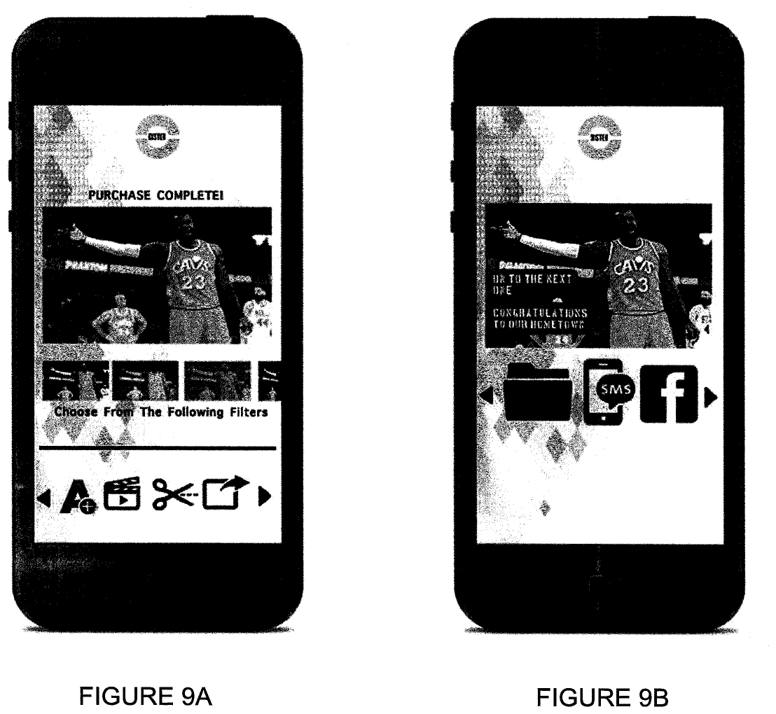

At 332, the central computer system 102 facilitates the communication of a high-resolution/high-quality version of the selected image to the first mobile device 200A, e.g., a version of the image 126 without any watermark/other indicia, along with the image rights 128 corresponding to that particular image 126. In varying embodiments, the image 126 may be communicated via the central computer system 102 (thereby ensuring suitable standards are adhered to by the various parties), or directly between devices 200A and 200B-D via the secure communications channel. In some embodiments, the user associated with the first mobile device 200A may be presented with various options regarding the selected image 126 including, for example and without limitation, licensing rights for reproduction, copyright issues, pricing per copy, pricing per use, restrictions on use, and the like, as well as options to customize and edit the image 126 (e.g. add filters or text, crop, etc.), as illustrated in FIG. 9A. Additionally, the user associated with the first mobile device 200A may also be presented with various options to share the image 126, such as via an associated social media account (e.g. Facebook, Twitter, etc), as illustrated in FIG. 9B.

At 334, the user account(s) associated with the first mobile device 200A is updated to reflect the acquisition of the selected image 126. For example, when an image 126 has an associated cost for use/copying/viewing, the user's account is suitably debited or charged the cost by the central computer system 102. It will be appreciated that the central computer system 102 may charge various fees to the users based upon transactions, monthly service, or the like. Operations thereafter with respect to FIG. 3 terminates after 334. Operations then terminate with respect to FIG. 3.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer: The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for location-based image capture between mobile devices, comprising:
receiving, from a first mobile device via a computer network, an image request comprising at least one keyword;
identifying a location corresponding to the image request in accordance with the at least one keyword;
identifying a second mobile device in proximity to the identified location having an image capture device;
communicating, via the computer network, the image request to the identified second mobile device;
receiving at least one image responsive to the image request from the identified second mobile device;
generating a notification responsive to the at least one image received from the identified second mobile device; and
communicating the generated notification of the at least one image to the first mobile device via the computer network,
wherein at least one of the receiving, identifying, and communicating is performed by a computer processor of a central computer system in communication with memory.

2. The method of claim 1, further comprising:
searching a data storage in communication with the computer processor of the central computer system, the data storage include a plurality of images;
retrieving, from the data storage, at least one previously acquired image responsive to the image request;
generating a modified version of the at least one previously acquired image, the modified version having at least one of a low resolution, a watermark, or a copy-prevention indicia; and
communicating the modified version of the at least one previously acquired image to the first mobile device.

3. The method of claim 2, further comprising:
generating a modified version of the at least one image received from the second mobile device, the modified version having at least one of a low resolution, a watermark, or a copy-prevention indicia; and
communicating the modified version of the at least one image received from the second mobile device to the first mobile device.

4. The method of claim 3, further comprising:
receiving, from the first mobile device, a selection corresponding to at least one of the at least one previously acquired image and the at least one received image, at the central computer system;
retrieving an unmodified version of the selected image and at least one usage right associated therewith; and
communicating the unmodified version of the selected image and the at least one usage right associated therewith to the first mobile device.

5. The method of claim 4, further comprising updating at least one user account associated with the first or second mobile device in response to the communication of the selected image.

6. The method of claim 1, further comprising establishing a secure communications channel between the first mobile device and the second mobile device via the computer network by a computer processor of the central computer system in communication with memory.

7. The method of claim 4, further comprising customizing the unmodified version of the selected image communicated to the first mobile device, wherein customizing is performed by a computer processor of the first mobile device.

8. The method of claim 4, further comprising updating at least one user account associated with the first or second mobile device in response to the communication of the selected image.

9. The method of claim 1, the method further comprises:
determining, at the central computer system, a proximity radius around the identified location based on the at least one keyword;
receiving a position signal from the second mobile device; and
identifying the second mobile device in proximity to the identified location based on the predetermined proximity radius around the identified location and the position signal received from the second mobile device.

10. A system for providing location-based image capture between mobile devices, the system comprising:
a central computer system comprising:
a processor;
a network interface in communication with the processor; and
memory in communication with the processor, the memory storing instructions that are executed by the processor to:
receive, from a first mobile device via a computer network, an image request comprising at least one keyword;
identify a location corresponding to the image request in accordance with the at least one keyword;
identify a second mobile device in proximity to the identified location having an image capture device;
communicate, via the computer network, the image request to the identified second mobile device;
receive at least one image responsive to the image request from the identified second mobile device;
generate a notification responsive to the at least one image received from the identified second mobile device; and
communicate the generated notification of the at least one image to the first mobile device via the computer network.

11. The system of claim 10, wherein the memory further stores instructions that are executed by the processor to:
generate at least one representative image, responsive to the image request, from at least one of a previously captured image or an image received from the second mobile device, wherein the representative image is a modified version of the previously capture image or image received from the second mobile;
communicate the representative image to the first mobile device;
receive, from the first mobile device, a selection corresponding to at least one of the representative images, at the central computer system;
retrieve an unmodified version of the selected representative image and at least one usage right associated therewith;
communicate the unmodified version of the selected representative image and the at least one usage right associated therewith to the first mobile device; and
update at least one user account associated with the first or second mobile device in response to the communication of the unmodified version of the selected representative image.

12. The system of claim 10, wherein the system further comprises:
the first mobile device; and
the second mobile device in proximity to the identified location;
wherein the second mobile device is in proximity to the identified location when the second mobile device is within a predetermined radius of the identified location, and wherein the predetermined radius is adjusted, at the central computer system.
